(19) United States
(12) Patent Application Publication
(10) Pub. No.: US 2015/0184647 A1
(43) Pub. Date: Jul. 2, 2015

(54) MODULAR PRESSURIZATION ELEMENT IN REVERSE OSMOSIS DESALINATION

(71) Applicant: Jayaram JAYASHRI, Singapore (SG)

(72) Inventor: Jayashri Jayaram, Singapore (SG)

(21) Appl. No.: 14/407,953

(22) PCT Filed: Sep. 27, 2012
(86) PCT No.: PCT/SG2012/000359

§ 371 Date: Dec. 13, 2014

(51) Int. Cl. F04B 43/073; F15B 3/00

(52) U.S. Cl. CPC F04B 43/073; F15B 3/00

(57) ABSTRACT

This present invention relates to a method of recovering very efficiently the energy of a waste stream, which is a by product of the desalination process. More specifically, this present invention relates to a method of using the waste stream to pressurize the clean feed. It also uses the invention as a high pressure seawater pump using another fresh water pump as the pressure source. This invention uses as its core technology a removable pressurization element that enables the quick insertion and removal of the pressurization element via a peristaltic process.

This present invention relates to a method of improving the efficiency of a reverse osmosis system by recovering very efficiently the energy of a waste stream, which is a by product of the desalination process. More specifically, this present invention relates to a method of using the waste stream to pressurize the clean feed and also a fresh water to seawater high pressure pump both by peristaltic compression

Osmosis is a process by which a semi-permeable membrane, separating two fluid streams of different salinities, tends to ensure equilibrium of the two fluids, such that the less saline liquid tends to flow into the more saline liquid. Reverse osmosis is a ‘reversal’ of the osmosis process where by the more saline solution is ‘pressurized’ above the osmotic pressure across a semi-permeable membrane, thereby transferring a ‘permeate’ across the dividing membrane.

For seawater, the osmotic pressure is approximately 60 bars and is dependant on the nature of concentration and composition of seawater. The ‘potable’ water obtained by this process is termed ‘permeate’ and the more concentrated water is termed ‘concentrate’ or ‘brine’. The ratio of the ‘feed’ liquid to the ‘permeate’ obtained is termed ‘recovery’ and typically 40-48%.

The remaining liquid, which is still at a high pressure is termed ‘concentrate’ and its energy is available for recovery, which is essentially what this Invention relates to.

Traditional methods of recovering this energy are,
Hydraulic Recovery Turbines comprising of
   Impulse turbines with unit efficiencies of around 85%
   [symbol] eaction turbines with unit efficiencies of around 75%
   [symbol] urbo Chargers of reasonable efficiencies
Works Exchanger types

Part of the present invention is a Work Exchanger type involves the pressurization of the feed using the waste energy of the concentrate.

Typically these devices such as described in U.S. Pat. No 3,791,968 use opposed piston/diaphragm pumps and these arrangements have several drawbacks. The device described in U.S. Pat. No. 3,791,968 is also restricted in the quantity of fluid that can be handled and is suited to small installations.

The Dual Work Exchanger Energy Recovery type also has several drawbacks, in that it is a piston accumulator type of device and having sliding components, is subject to wear, seawater has low lubricating properties. It also has to have valves and again prone to leaks and sealing is an issue.

Other energy recovery devices employ pistons of different areas with connecting mechanisms as described in U.S. Pat. No. 3,558,242 and as with the above type has various seals to minimize leaks to atmosphere.

Other energy recovery devices as described in Australian Patent No. 2011100390 while efficient does not allow for a modular extraction of the pressurization element.

The principal behind the Invention is to provide a device for recovering the ‘waste’ or ‘Concentrate’ energy coming out of the reverse osmosis membranes and at the same time provide for a very simple removal and reinstallation of the main pressurization element that does not require the removal of the entire assembly.

The fundamental principal behind this is the utilization of several technologies as briefly stated below.
Utilization of ordinary polymer materials like PVC, gPVC for the Inner Containment Shell that is primarily there to cater to the corrosive nature of seawater.
Providing an Outer Containment Shell around this inner containment shell that is primarily there to cater to the high pressure that will be required for the process.
Filling the gap between the inner containment shell and the outer containment shell with a polymer that will support the pressure contained within the inner containment core and which in turn is supported by the outer containment core.

The novel inventive step being the,
The modular construction of the pressurization element that enables it to be removed and replaced as a single unit without disturbing much of the system piping using the peristaltic pressurization process for pressure transfer.

### DETAILED DESCRIPTION

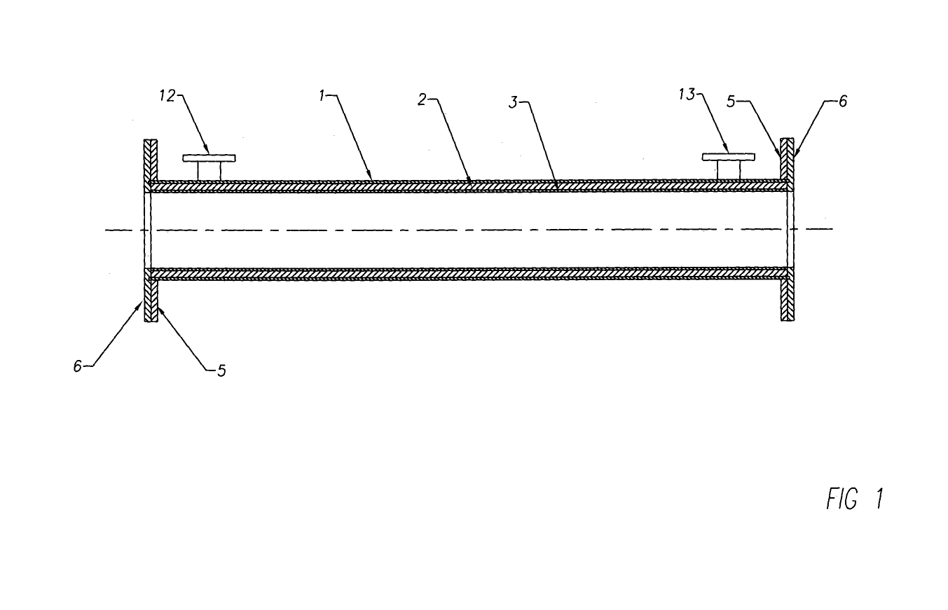

### Reference Will Now be Made to FIG. 1

The Outer Containment Shell 1 is provided with Flanges 5. There are two Inner Containment Shell flanges 6 into which the Inner Containment Shell 3 is fixed into as shown.

A cavity is formed between the outer diameter of the Inner Containment Shell 3 and the inner diameter of the Outer Containment Shell 1. This cavity is filled with a fiberglass mat with resin and/or filled with resin or a polymer epoxy 2 which then forms a solid ‘shell’. Nozzles 12 & 13 are provided into the Outer Containment Shell 1 and do not penetrate through to the inner diameter of the Inner Containment Shell 3.

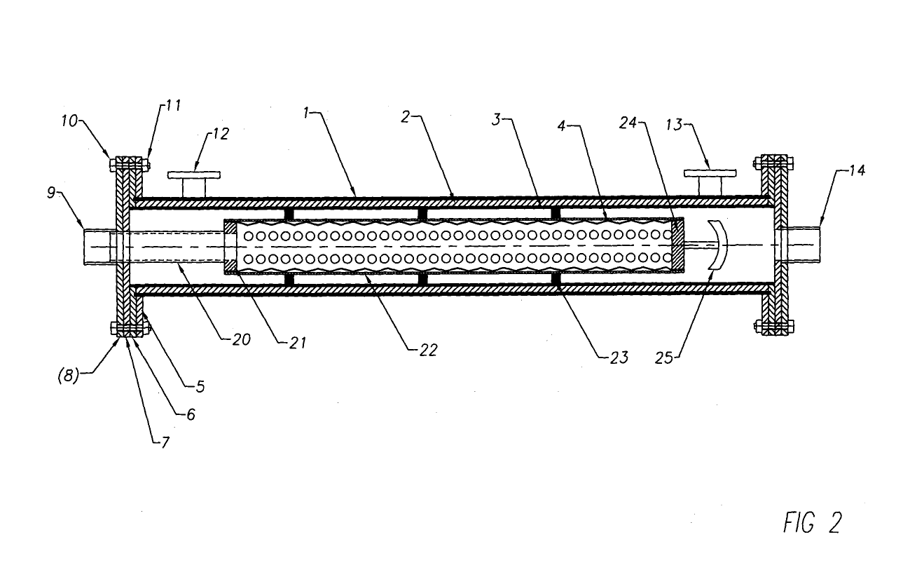

### Reference Will Now be Made to FIG. 2

There are two off Closing Flanges 7 one of which has attached the Feed Transfer Tube 20, the Backing Flange 8, Feed Transfer Coupling 9 and to the other the Concentrate Transfer Coupling 14.

The other end of the Feed Transfer Tube 20 is attached the feed transfer tube Holder 21 that has one end of a Elastomeric Containment Membrane 4 attached to it while the other end is fixed to the Plug Holder 24. Encapsulating the Elastomeric Containment Membrane 4 is a Perforated Containment Tube 22 that which surrounds the Elastomeric Containment Membrane 4.

Attached to the Plug Holder 24 is a Deflector Plate 25. The sealing between the

Elastomeric Containment Membrane 4, the Feed Transfer Tube Holder 21, the Plug Holder 24 and the Perforated Containment Tube 22 is done by a flexible silicone/epoxy sealing.

The Backing Flange 8 attaches to the Closing Flange 7 by means of Bolt 10 and Nut 11. To the Perforated Containment Tube 22 are attached the Centralizers 23 that which ensures that' the Perforated Containment Tube 22 is centralized within the Inner Casing Cover 3. The Deflector Plate 25 serves to dissipate the impact energy of the Concentrate entering the Inner Containment Shell 3.

The entire assembly comprising the Deflector Plate 25, the Perforated Containment Tube 22 the Plug Holder 24 the Elastomeric Containment Membrane 4 the Feed Transfer Tube Holder 21, the Feed Transfer Tube 20 the Closing Flange 7 and the Backing Flange 8 are all removable as one element. This is achieved by removing the 120 Bolt 10 and Nut 11 on the Feed Transfer Coupling 9.

This assembly is called the Pressurization Element.

The entire assembly mentioned above is easily introduced and removed into and from 125 the Inner Containment Shell 3.

This complete constructed component is termed the Pressure Exchanger.

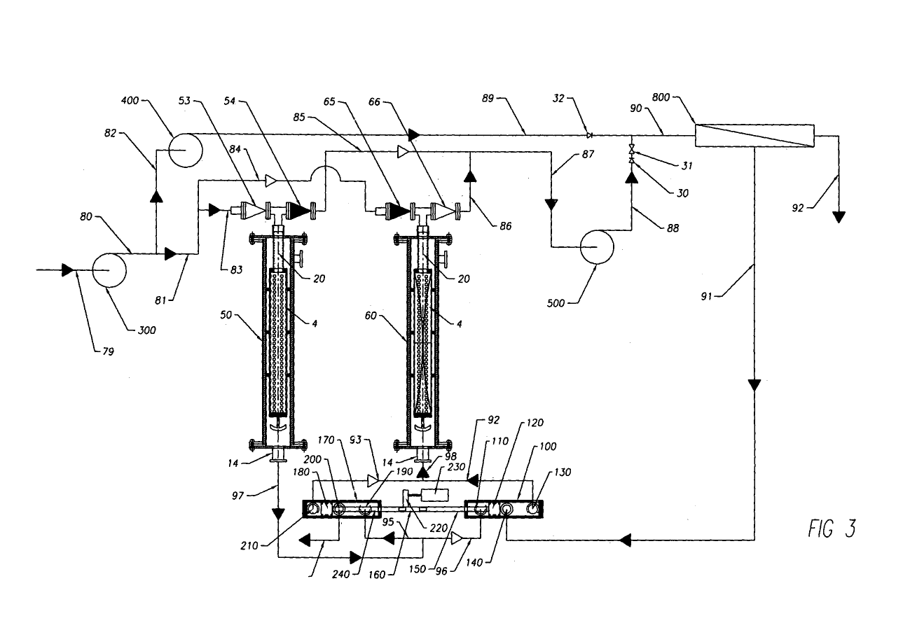

### Reference Will Now be Made to FIG. 3

The entire system as shown in FIG. 3 is assumed to be filled with clean filtered seawater, purged of all air and is ready for start.

Pressure Exchangers 50 and 60 form the Energy Recovery circuit of the device.

Stream 79 is clean, filtered and pretreated seawater that enters the suction of the LP Pump 300 and exits as stream 80 at a nominal pressure of 3 barg.

This stream 80 splits into two streams, stream 81 & stream 82.

Stream 82 enters the suction of the High Pressure Pump 400 and exits as stream 89 while stream 81 splits into two streams, stream 83 and stream 84.

Stream 83 enters the Pressure Exchanger 50 through check valve 53 and enters the elastomeric containment membrane 4 via the feed transfer tube 20. As the Elastomeric containment membrane 4 expands and fills with stream 83, it displaces an already filled volume of liquid which exits the pressure exchanger 50 via concentrate coupling 14 as stream 97.

Stream 97 splits into two streams 95 & 96.

Stream 95 enters the transfer valve 170 via port 190. As the position of the block 180 is downstream of port 200, the stream 95 exits the transfer valve 170 via this exhaust port 200 as stream 94.

Stream 96 does not flow as port 110 is closed.

Stream 84 does not flow as the check valve 65 is closed due to the downstream pressure.

Stream 89 combines with stream 88 and becomes stream 90 and enters the reverse osmosis membrane 800. The stream is split in two and the permeate stream 92 exits as desalinated water and the concentrate exits as stream 91. Stream 90 is at a nominal pressure of 60 barg

Stream 91 at a nominal pressure of 58 barg enters the transfer valve 100 at port 140 and exits as stream 92 as the position of the block 120 opens port 130. Stream 92 enters the pressure exchanger 60 through the concentrate coupling 14 as Stream 98 and pressurizes the elastomeric containment membrane 4 to the pressure of 58 barg and the liquid inside the elastomeric containment membrane 4 now exits as stream 86 via the check valve 66. Check valve 65 is closed as the pressure is greater than 3 barg.

Stream 93 does not flow as port 210 on Transfer Valve 170 is closed by the position of block 200.

175 Stream 86 becomes stream 87 and enters the suction of the circulation pump 500 and exits as stream 88 at a nominal pressure of 60 barg flowing through check valve 30 and control valve 31 and joins stream 89 to become stream 90.

The position of the block 120 on transfer valve 100 and the position of block 180 on 180 transfer valve 170 control's the flow of concentrate through the pressure exchangers.

Block 120 and block 180 are joined by rods 240 and 150. The transfer valves 100 & 170 are then sequenced by an actuator 230 that is coupled to the rods 240 and 150 by link 220.

The entire sequence is reversed when the Block 120 and block 180 are repositioned by the actuator 230 such that port 210 and port 110 are open

The Casing can also be produced by using an ordinary grade of carbon steel or 190 stainless that which is suitably coated in a polymer coat or rubber.

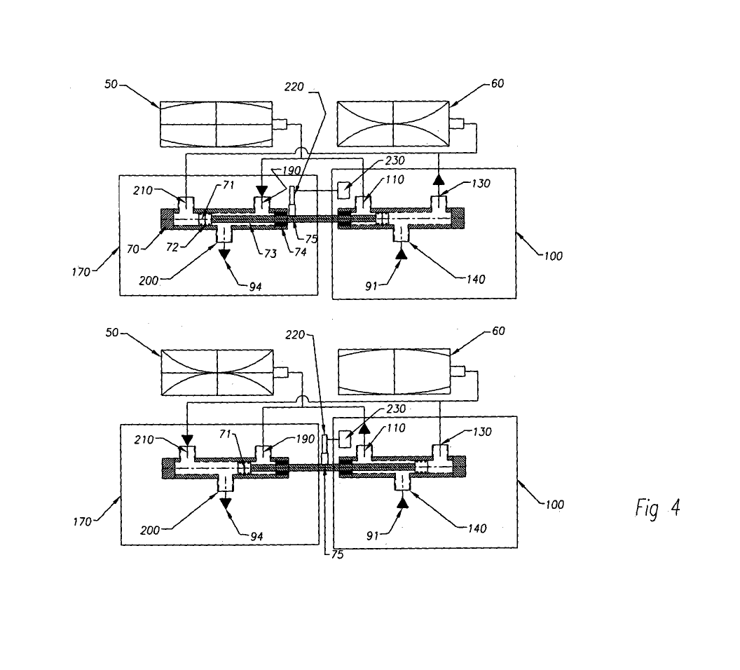

### Reference Will Now be Made to FIG. 4

The workings of the Transfer Valve 100 & 170 will now be explained.

Each Transfer Valve 100 & 170 essentially consists of a Cylinder Body 70, Piston 71, Piston Rings 72, Piston Rod 73, Piston Rod Packing 74. On the Body 70 are provide three nozzles that serve as ports for the seawater to flow through depending on the position of the Piston 71.

The Piston Rod 73 of the two Transfer Valves 100 & 170 are joined together with a Coupling 75 with the position of the Piston 71 in the position as shown in each Transfer Valve 100 & 170.

To the Coupling 75 is attached a Link 220 that is also attached to an Actuator 230.

Explanation of the pressure distribution within the two Transfer Valves 100 & 170 is now made.

Stream 91 at a pressure of 58 barg enters the Transfer Valve 100 at port 140. This exerts a force on the Piston 71. At the same time Stream 96 enters the Transfer Valve 100 at port 110 at a pressure of 3 barg and as a consequence the differential pressure tends to push the Piston 71 to the left.

Stream 93 on port 210 on Transfer Valve 170 is also at the pressure of Stream 92 minus a very small pressure drop as it is exposed to Stream 91 which is at 58 barg and tends to push the Piston 71 of the Transfer Valve 179 to the right.

The net result the above is that the forces acting on the Pistons 71 of the Transfer Valves 100 & 170 are very little and consequently the force required to change the position of the Pistons 71 for the next sequence of operation is small.

The above Transfer Valve 100 & 170 is essentially constructed in Carbon Steel with an electroless nickel coating or can be manufactured in seawater resistant materials 225 like Stainless Steel, Duplex and or Super Duplex Stainless Steels, Titanium

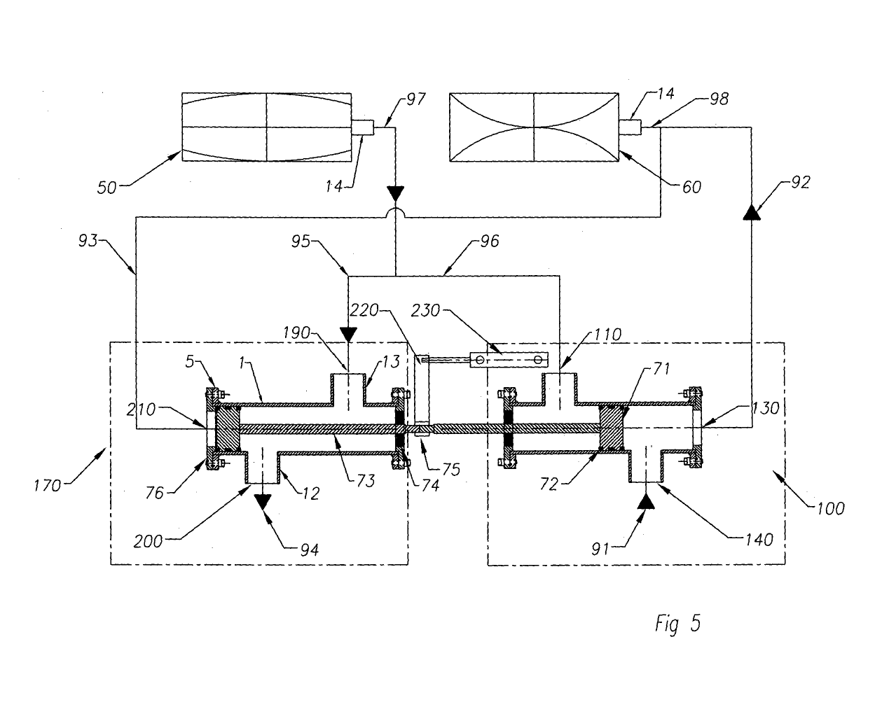

### Reference Will Now be Made to FIG. 5

In this figure as can be seen the Transfer Valve 100 & 170 Cylinder Body is fabricated and is actually an Outer Containment Shell 1 and the Piston 71 is provided with Piston Rings 72.

The Pistons Rings 72 can seal along the inner diameter of the Cylinder Body 70 and also seal at the end face of the cylinder as well. Both Transfer Valves 100 & 170 are connected together with Piston Rods 73

A Flange 76 provides for port 210 stream 93

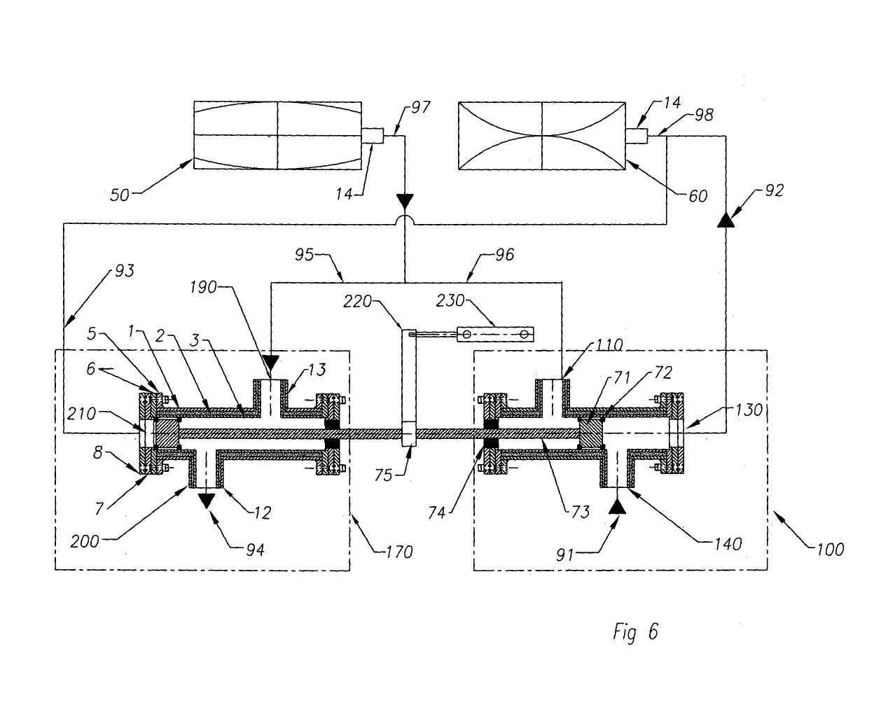

### Reference Will Now be Made to FIG. 6

In this Figure the construction of the Transfer Valve body is as described earlier.

In this construction, the Cylinder Body consists on an Outer Containment Shell 1 provided with flanges 5. It is also provided with an Inner Containment Shell 3 that which has flanges 6. The cavity formed between the inner diameter of the Outer Containment Shell 1 and the Inner Containment Shell 2 is filled with a fiberglass resin 2 or a Polymer Epoxy or a Polyurethane material via the nozzle 12 & 13 as shown.

The Transfer Valves 100 & 170 contain the Pistons 71 is provided with Piston Rings 72.

The Piston Rings 72 seal at the face of the flange 6.

1. A Modular pressurization element essentially constructed with the Elastomeric Containment membrane in a flexible polymer material that which is rigidly fixed and sealed on both ends with a holder which is completely enclosed in a perforated containment tube made out of a PVC, ABS or similar material or a metal perforated tube made in exotic material such as Titanium, Duplex Stainless Steel or such seawater resistant material with a deflector plate attached to the Plug Holder that may or may not be provided and the Outer Containment Shell is a Carbon Steel material that which is or is not treated or coated in a rubber or other polymer coat or made out of a Stainless Steel material or made in exotic material such as Titanium, Duplex Stainless Steel or such seawater resistant material and the Inner Containment Shell made out of a polymer material like PVC, ABS with a fiberglass mat and resin applied to it with the cavity between the Outer Containment Shell and the Inner Containment Shell being filled with a Fiberglass resin with or without chopped glass fiber mat or a Polyurethane material.

2. A valve assembly essentially constructed with the Transfer valve consisting of a cylinder body, piston, piston rings, packing, and rod, manufactured in carbon steel and is electroless nickel coated, that which is connected to another by means of a coupling and link assembly and the sealing of the liquids occurring at the circumferential surfaces between the piston rings and the cylinder body or in another embodiment the sealing occurring at the face of the piston and the cylinder body and the Transfer valve consisting of the Outer Containment Shell, the Inner Containment Shell, the fiberglass resin, polymer epoxy, or polyurethane fill in between the outer containment and inner containment shells with piston, piston rings, piston rods
